(19) United States
(12) Patent Application Publication
(10) Pub. No.: US 2013/0326950 A1
(43) Pub. Date: Dec. 12, 2013

(54) Vertical Agricultural Structure

(71) Applicant: Steven M. Nilles, Wheaton, IL (US)

(72) Inventor: Steven M. Nilles, Wheaton, IL (US)

(21) Appl. No.: 13/913,103

(22) Filed: Jun. 7, 2013

Related U.S. Application Data
(60) Provisional application No. 61/657,475, filed on Jun. 8, 2012.

(51) Int. Cl. A01G 31/06

(52) U.S. Cl. CPC A01G 31/06
USPC 47/62 R

(57) ABSTRACT

Disclosed are modular and stackable cultivation systems and growth bays, and purpose built structures including the systems and bays that are adaptable for crop cultivation and find use for methods of agricultural growth using soil, hydroponic, or aeroponic-based systems.

### CROSS-REFERENCE TO RELATED APPLICATIONS

This application claims the benefit of priority to U.S. Provisional Patent application Ser. No. 61/657,475, filed Jun. 8, 2012, the entirety of which is hereby incorporated by reference.

### FIELD

The disclosure relates to vertical agricultural structures, systems, and associated methods for growing plants, such as food crops.

### BACKGROUND

The increasing rate of growth in the global population has put a strain on food supply. As the global population growth is expected to increase, there is a need to increase food production. Further, in some regions of the world (e.g., high population density, challenging climate conditions, etc.) the costs associated with food production and/or food transportation to consumers can be very high. Therefore, there is also a need to decrease the costs associated with food production and transportation.

Aeroponic and hydroponic processes allow for the growth of plants in an environment without the use of soil. While aeroponics technology has emerged over the past few decades, in that time, a number of different aeroponic systems have been developed. In general, an aeroponic system includes a nutrient-supplemented water mixture that is continually applied to a plant's root system as a spray, mist, or fog which can be generated by a spray nozzle or other device so that it aerates the nutrient-rich water mixture. Most commonly, the dangling roots and the plant's lower stem are sprayed with an atomized nutrient-rich solution. The roots of the plant are separated from the leaves and crown, often called the “canopy,” by a plant supporting structure, such as support membranes or structures that may include closed cell foam compressed around a portion of the plant's lower stem, and form part of the plant-receiving opening (aperture) in an aeroponic chamber. For larger plants, trellising can be used to help support and suspend the weight of vegetation and fruit.

Hydroponic growth systems are similar to aeroponics in that they do not require soil for plant growth, but vary from aeroponics in that hydroponic systems typically submerge the plant root system in a medium comprising a nutrient-rich water mixture. As such, hydroponics also allows for plant support structures that can float on the water mixture, keeping the canopy out of the water, while keeping the root system submerged in water. Thus, typical aeroponic and hydroponic growing systems provide nutrients directly to the roots of suspended plants within a closed or semi-closed environment and can provide significant advantages relative to standard soil-based agriculture methods. Such advantages can include increase growth efficiency and root development, less impact on the environment, ability to control growing conditions (temperature and air control) thereby increasing growing flexibility.

Although some designs have attempted to utilize growing space more effectively, these efforts have fallen short.

### SUMMARY

In an aspect, the disclosure provides a cultivation system, comprising a plurality of stackable growth regions, wherein each growth region has substantially the same physical dimensions and comprises a plurality of growth bays, wherein each of the plurality of growth bays comprises, in a vertically oriented dimension, from low to high: a) a plant zone comprising one or a plurality of grow modules; b) an airspace region located immediately above the plant zone; c) a lighting region comprising a series of light emitting diode (LED) lights located above the airspace; and d) a structural region, wherein the structural region provides structural support for (i) the LED lights of the lighting region, and (ii) an optional second growth region located above the structural region. In embodiments of this aspect, the growth region further comprises exterior windows comprising a wavelength-specific high performance coating which provides high transmission of blue, red, and selected UV light spectrums and which may further optionally reflect infrared heat.

In embodiments of this aspect, the system may further comprise solar control blinds that may be optionally motorized and solar programmable, and which can function to reflect and/or redistribute natural ambient daylight to the interior regions of the floor.

In embodiments of this aspect, the system may further comprise a high performance light diffusion coating on at least a portion of a ceiling surface and/or a portion of a bottom surface of the individual floor, wherein the coating comprises mica or silicone beads, or both mica and silicone beads.

In embodiments of this aspect, the system may further comprise a HVAC system that is programmable and controls one or more of air exchange rates, temperature, and humidity on the individual floor, wherein the air exchange rate, temperature, and/or humidity that can be adjusted for any selected crop, such that the growth conditions allow for growth and propagation of the selected crop. In further embodiments, the HVAC system provides for optimized growth conditions (e.g., air exchange rate, temperature, and/or humidity) for a selected crop.

In embodiments of this aspect, the system may further comprise a condensate collection system which harvests water from HVAC coils during cooling and dehumidification cycles, wherein the water can optionally be collected for use in a grow module.

In embodiments of this aspect, the system may further comprise a floor plate geometry orientation and layout design that maximizes net grow module area, harvesting access and deep daylight penetration at east and west exposures.

In embodiments of this aspect, the system may further comprise, or comprises a portion of, a purpose built structure comprising a plurality of individual floors that are each adapted for crop cultivation, wherein each individual floor has climate and growth conditions that are controllable independently from the climate and growth conditions of any of the other individual floors.

In an aspect, the disclosure provides a purpose built structure comprising a plurality of individual floors that are each adapted for crop cultivation, wherein each individual floor has climate and growth conditions that are controllable independently from the climate and growth conditions of any of the other individual floors.

In embodiments of this aspect, the structure may further comprise one or more movable grow modules designed for crop harvesting and modular in dimension.

In embodiments of this aspect, the structure may further comprise an artificial lighting comprising a programmable wavelength-specific light emitting diode (LED) system that comprises red, blue and white LEDs which provide wavelength specific lighting programmable for crop-specific selection and optionally solar controlled based on location of the LEDs within the floor.

In embodiments of this aspect, the structure may further comprise exterior windows comprising a wavelength-specific high performance coating which provides high transmission of blue, red, and selected UV light spectrums and which reflects infrared heat.

In embodiments of this aspect, the structure may further comprise solar control blinds that are optionally motorized and solar programmable, and which can reflect and redistribute natural ambient daylight to the interior regions of the floor.

In embodiments of this aspect, the structure may further comprise a high performance light diffusion coating on at least a portion of a ceiling surface and/or a portion of a bottom surface of the individual floor, wherein the coating comprises mica or silicone beads, or both mica and silicone beads.

In embodiments of this aspect, the structure may further comprise a HVAC system that is programmable and controls one or more of air exchange rates, temperature, and humidity on the individual floor, wherein the air exchange rate, temperature, and/or humidity that can be adjusted for any selected crop.

In embodiments of this aspect, the structure may further comprise a condensate collection system which harvests water from HVAC coils during cooling and dehumidification cycles, wherein the water can optionally be collected for use in a grow module.

In embodiments of this aspect, the structure may comprise a floor plate geometry orientation and layout design that maximizes net grow module area, harvesting access and deep daylight penetration at east and west exposures.

In embodiments of this aspect, the structure may further comprise an organic waste digester and co-generation plant, wherein the organic waste digester can nutrient slurry for grow module units and methane gas for the co-generation plant, wherein the co-generation plant can provide power for the purpose built structure.

In embodiments of this aspect, the structure may further comprise an additional floor designed for process and packaging of crops harvested from the individual cultivation floors.

In embodiments of this aspect, the structure may further comprise a rooftop orchard comprising a screenwall and optional suspended catwalk areas provided for harvesting and building maintenance.

In embodiments of this aspect, the structure may further comprise an additional floor designed for propagation for crop cuttings and crop cloning.

In embodiments of this aspect, the structure may further comprise renewable power sources selected from vertical wind turbines, horizontal wind turbines, and PV sunshade panels, or any combination thereof.

In a further aspect, the disclosure provides a growth bay that comprises, in a vertically oriented dimension, from low to high: a) a plant zone comprising one or a plurality of grow modules; b) an airspace region located immediately above the plant zone; c) a lighting region comprising a series of light emitting diode (LED) lights located above the airspace; and d) a structural region, wherein the structural region provides structural support for (i) the LED lights of the lighting region, and (ii) an optional second growth region located above the structural region.

In any of the above aspects and embodiments, the system or structure may be adapted for standard soil-based agricultural growth. In any of the above aspects and embodiments, the system or structure may be adapted for hydroponic-based agricultural growth. In any of the above aspects and embodiments, the system or structure is adapted for aeroponic-based agricultural growth.

### BRIEF DESCRIPTION OF THE DRAWINGS

FIG. 1 depicts an embodiment of modular growth containers (or grow modules) in non-limiting dimensions and arrangements for aeroponic or hydroponic growth.

FIG. 2 depicts an embodiment of floor-to-ceiling arrangement of plant zone with grow modules, airspace, lighting, and structural support.

FIG. 3 depicts various views (top, side, end) of an embodiment of a growth floor arrangement that maximizes growth space.

FIG. 4 depicts an illustration of daylight analysis through the cross-section of a growth floor within the scope of the embodiments, and how LED lighting can be utilized to equalize the light across the entire floor section.

FIG. 5 depicts various views of an embodiment of reflective louver/blind designs that may be adjusted to maximize natural light.

FIG. 6 depicts embodiments relating to LED lighting organization (adjustable heights, wavelengths, comprising solar sensors that can automatically adjust LED light output).

FIG. 7 depicts non-limiting advantages of embodiments relating to air systems controlled on a floor-by-floor basis, relative to a central air system.

FIG. 8 depicts an embodiment of a growth floor illustrating a mechanical design for air flow, humidity controls, and temperature controls.

FIG. 9 depicts an embodiment of a growth floor illustrating a water and plumbing design.

FIG. 10 depicts embodiments relating to enclosure technology (e.g., windows, blinds, reflectors).

FIG. 11 depicts an embodiment an external view of a vertical urban farm comprising various floor arrangements.

FIG. 12 depicts an embodiment of a lower level floor plan of a vertical urban farm.

FIG. 13 depicts an embodiment of a ground or entry level floor plan of a vertical urban farm.

FIG. 14 depicts an embodiment of a crop processing floor plan of a vertical urban farm.

FIG. 15 depicts an embodiment of a residential floor plan of a vertical urban farm.

FIG. 16 depicts an embodiment of a typical low level farming floor plan of a vertical urban farm.

FIG. 17 depicts an enlarged view of one embodiment of a growth bay floor plan.

FIG. 18 depicts an embodiment of a rooftop orchard level floor plan.

FIG. 19 depicts an embodiment of a rooftop orchard floor plan that also includes wind turbines.

FIG. 20 depicts various views of an embodiment of a vertical urban farm (or “purpose built structure”).

FIG. 21 depicts various views of an embodiment of a vertical urban farm showing internal structures (e.g., lower level, market and ground level, processing level, cloning level, growth levels, mechanical levels, and rooftop orchard).

FIG. 22 depicts an embodiment of growth bays on two vertically arranged floors.

FIG. 23 depicts an embodiment of daytime lighting for growth bays on five vertically arranged floors (with illustrative purple LED light identified).

FIG. 24 depicts an embodiment of night time lighting for growth bays on five vertically arranged floors (with illustrative purple LED light identified, and showing closed internal reflector blinds to prevent loss of light through windows).

FIG. 25 depicts an external view of a vertical urban farm that comprises solar energy panels on the window blinds and shutter panels.

FIG. 26 depicts an embodiment of predicted renewable power that can be generated by wind turbine.

FIG. 27 depicts an embodiment of renewable power using bio mass and capture of waste heat for further production of energy and materials (e.g., water heating and fertilizer generation).

### DETAILED DESCRIPTION

Materials and methods that are generally available and known to those of skill in the relevant arts, including building construction; component manufacture and assembly, automated and manually controllable HVAC and environmental control systems; plumbing and irrigation systems; electrical systems; crop growth, cultivation, propagation, and harvesting; and the like may be used in connection with the various aspects and embodiments described herein.

The disclosure provides, among other aspects, a purpose-built vertical agricultural building structure comprising a plurality of vertically spaced growing levels (e.g., floors) where each level or floor can optionally be environmentally controlled and/or isolated independently of any of the other levels or floors. That is, the structures and systems provided herein optionally allow for complete isolation and control of atmospheric (climate) conditions within each individual level, allowing for a variety of crops requiring a variety of optimal growth conditions to be grown within a single vertical structure. The structures provided herein may be used with any type of agricultural method (e.g., soil, hydroponic, aeroponic, etc.) but may provide additional advantages when used in conjunction with aeroponic or hydroponic systems.

As a result, the vertical agriculture structures, systems and methods provided herein, which can be used in combination with standard soil-based agriculture, or aeroponic and/or hydroponic based technology can be commercially viable, requires less physical space/footprint, and generates edible crops more quickly than traditional farming methods.

In one aspect, the disclosure generally relates to a vertical agricultural structure for crop cultivation. The vertical agricultural structure comprises a number of aspects and embodiments which, when considered alone or in any combination, provide for advantages over existing vertical agricultural growing technology. Any number of the aspects and embodiments disclosed herein can be combined in order to construct a specific purpose structure such as, for example, a structure in an urban setting (e.g., a multi-floor building) for growing and harvesting various food crops using any cultivation technology (i.e., soil, hydroponic, aeroponic). In certain aspects, the disclosure provides an economically viable method to grow, harvest, and sell food crops in regions and in markets where conventional agriculture is not viable due to absence of arable land, limited water supply, and/or climatic conditions (e.g., extreme temperatures, humidity, etc.).

The growing systems disclosed herein relate to any one or combination of the following non-limiting aspects, embodiments, and advantages.

Aeroponic Grow Modules.

Aeroponic grow modules are designed for modularity and organization into efficient growth bays in order to provide for maximum growing area for any particular geographical location. In some embodiments an individual module can vary from about 1-3 m (W)×1-3 m (L) and vary in height (e.g., from about 0.5 m to about 2 m). In embodiments a plurality of the modules can be organized into larger containers, (approximately 8.00 m(1)×1.50 m(w)×90 cm(h)) which can be organized into a larger growing bay (approximately 8.001×7.80 w×90 h) that are movable for harvesting and modular in dimension providing maximum grow area and efficiencies taking advantage of both daylight and artificial lighting. The grow modules can incorporate any existing aeroponic growing structure that includes, for example, one or more openings/apertures adapted to support a plant, a device such as, for example, a misting nozzle, for applying the water/nutrient spray, mist, or fog to the plant root system, and other standard features that are known in the art (e.g., a growing medium, a nutrient water reservoir, a plumbing system linked to a nutrient water reservoir, a water recovery system, a ventilation system, etc). The grow modules can be made of any appropriate material known in the art such as, for example, plastic, glass, metal, fiberglass and the like. In alternative embodiments, the grow modules can be constructed for standard soil-based growth and/or hydroponic-based growth.

Programmable Wavelength Specific LED Lighting.

Programmable LED lighting fixtures utilizing red, blue, and white LED's provide wavelength specific lighting programmable for crop specific selection and solar controlled by bay and row location maximizing grow rates for continuous cycles (e.g., 24 hours, adjustable based on the season/time of year) and take advantage of daylight harvesting. In some embodiments, the LED lighting may be adjusted to provide light at wavelengths ranging from ultraviolet to infrared or near infrared. In some embodiments, the LED lighting may be adjusted to provide light from about 380 nm to about 750 nm (e.g., about 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, or about 750, and including any wavelength ranges and integers falling within the broader range of 380 nm -750 nm). One of skill in the art will be able to identify and adjust particular wavelengths for optimal growth and energy usage based on the amount of ambient daylight received at a particular location (ie., both geographically, and within the location of a particular structure, as described herein) and the particular crop being cultivated.

Wavelength Specific High Performance Glazing.

High performance glass coating for argon filled IG glazing units which provides high transmission of blue, red and selected UV light spectrums and reflects infrared heat to optimize plant growth rates and reduce cooling loads.

Solar Control Blinds.

Motorized and solar programmable blind system which reflects, and redistributes daylight to near uniform grow module depths maximizing plant growth by row depth and reducing the need for artificial lighting and resultant power use and internal heat loads. Such blinds may advantageously be in the form of a plurality of rotatable slats thus permitting selective reflection of natural sunlight and artificial (LED) light. Embodiments provide for the manual or automated control of the programmable blind system.

High Performance Light Diffusion Coatings.

High performance coating utilizing mica and/or silicone beads which provide high diffuse reflection of natural light within the grow floor ceiling structure.

Reflective and Retractable Shades.

To help maximize the efficiency of the LED lighting, particularly at night, removable/retractable shades can be fit to the windows which can reflect the LED light toward the interior of the growth floor and plants.

Grow Floor Plate Geometry.

Floor plate geometry orientation and layout design to maximize net grow module area, harvesting access and deep daylight penetration. The structure is located, configured or oriented so that west outer exposures can transmit natural light to the growing areas within the structure.

Condensate Collection Systems.

Condensate collection system harvests water from HVAC coils during cooling and dehumidification cycles. Water is collected for aeroponic, hydroponic, or soil-based grow units. Nutrients and minerals are added to the condensate water in storage tanks at the underground level specific to selected crop needs. Estimated condensation collection is 500,000 gal/year.

Organic Waste Digester/Co-Generation Plant.

Organic waste digester and co-generation plant provides nutrient slurry for the grow units and methane gas for a co-generation plant providing power for growth related needs such as, for example, aeroponic spray pumps, HVAC systems, and lighting loads.

Roof-Top Orchard.

A screenwall protected roof top orchard area may be provided for high value crops requiring an exterior environment. Suspended catwalk areas are provided for harvesting and building maintenance.

HVAC System.

Isolatable floor-by-floor HVAC system specific for required high volume air exchange rates, as well as thermal and humidity control and optimization for selected crops. The system has the flexibility for floor by floor environmental isolation and control, and thus, flexibility to provide crops with optimum outside air, humidity and temperature conditions. In some embodiments temperature levels may be maintained from about 5° C. to about 50° C. (e.g., about 5, 6, 7, 8, 9, 10, 11, 12, 13, 14, 15, 16, 17, 18, 19, 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., or about 50° C.). In some embodiments, the humidity levels may be maintained from about 40% to about 100% (e.g., about 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or about 100%).

Package and Process Floors.

One or more levels may be used for process and packaging of selected crops for wholesale distribution.

Cloning.

One or more levels may be used for crop propagation (e.g., sprouting, crop cuttings, etc.) ready for planting in typical grow floor units.

Renewable Power Sources.

The building includes vertical and horizontal wind turbines and PV sunshade panels (suitably on the north (southern hemisphere) or south (northern hemisphere) façades) and may provide 58,000 kwh per year.

Building Site Planning.

The building placement any of the purpose built structure(s) (see, e.g., Phase I and Phase II Towers in the Drawings) suitably allows for unobstructed E/W solar penetration to all growing floor maximizing deep space daylight harvesting.

External Orchards.

The existing area surrounding any purpose built structure (e.g., a municipal parking lot) can be planted with any viable orchard tree such as, for example, date palms that can optionally be irrigated by grey water collected from the tower.

Building Core Design.

The building core is designed specifically for vertical transport and processing of crops from seeding through harvest and wholesale distribution. The north orientation allows for maximum grow and daylight exposure. The exterior face of the concrete superstructure is insulated and clad to optimize thermal mass cooling.

Harvestable crops can be produced using the structures, systems, and methods described herein much more quickly when compared to standard soil-based agricultural methods. In some embodiments a crop such as, for example, strawberries, tomatoes (e.g., cherry tomatoes, vine ripe tomatoes, heirloom tomatoes, plum tomatoes, etc.), lettuce (e.g., leaf lettuce, iceberg lettuce, romaine lettuce, arugula, baby leaf lettuces such as spinach), bell peppers (e.g., red, yellow, orange, green), zucchini, cucumber, eggplant, and herbs (e.g., parsley, sage, rosemary, thyme, chervil, oregano, cilantro, dill weed, basil, lavender, etc.) can be grown and harvested in about 28 days to about 60 days.

### EXAMPLES

### Example 1

### Vertical Urban Aeroponic Prototype (VUAP)

A vertical urban aeroponic prototype (VUAP) is sited and designed specifically for the location of Abu Dhabi in the United Arab Emirates (UAE). In this region conventional agriculture is not viable due to absence of a number of necessary conditions (e.g., arable land, fresh water supply, and/or climatic conditions), and is further complication by strategic national concerns related to food security. The current VUAP design takes advantage of the regions abundant daylight, high humidity levels and attractive power rates available to commercial growers.

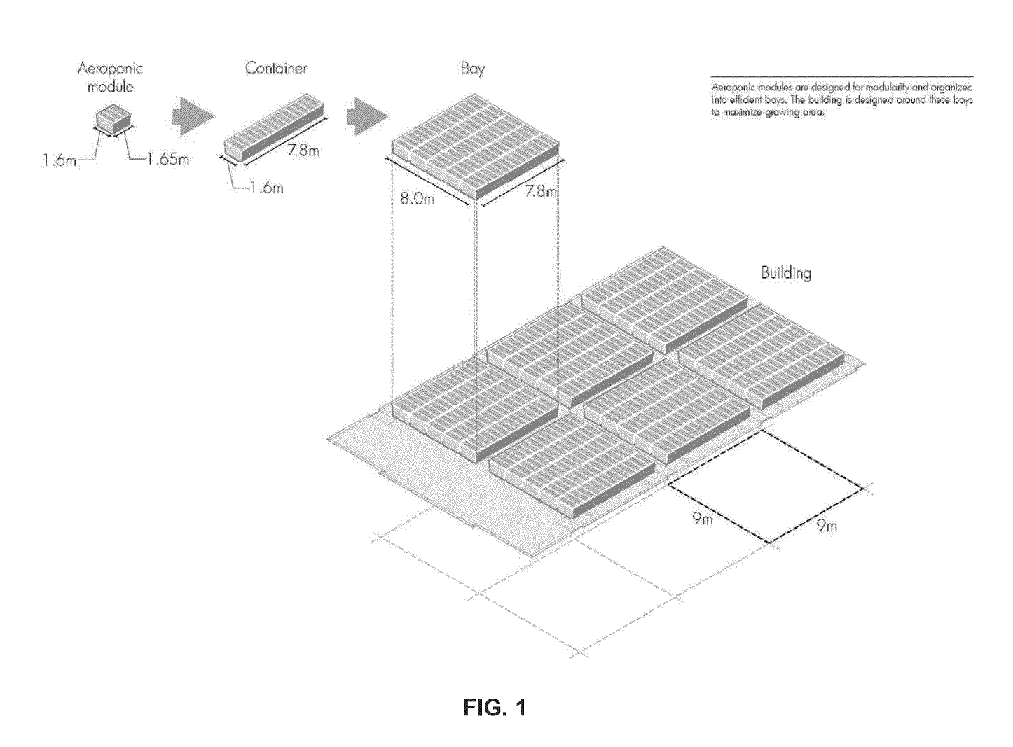

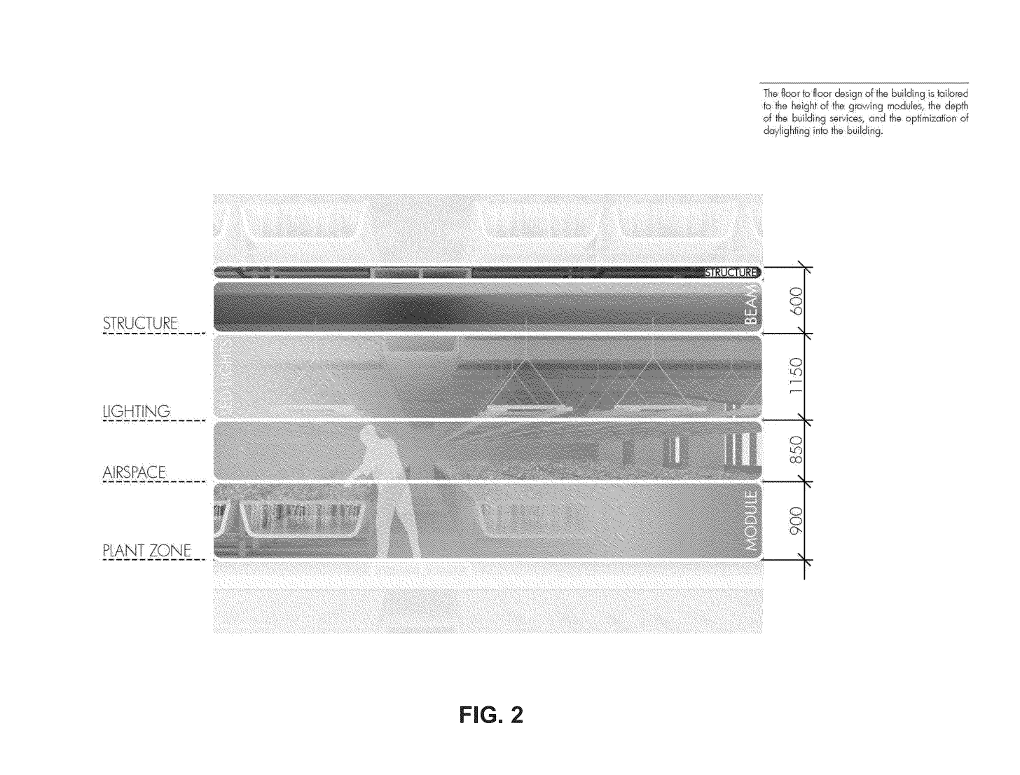

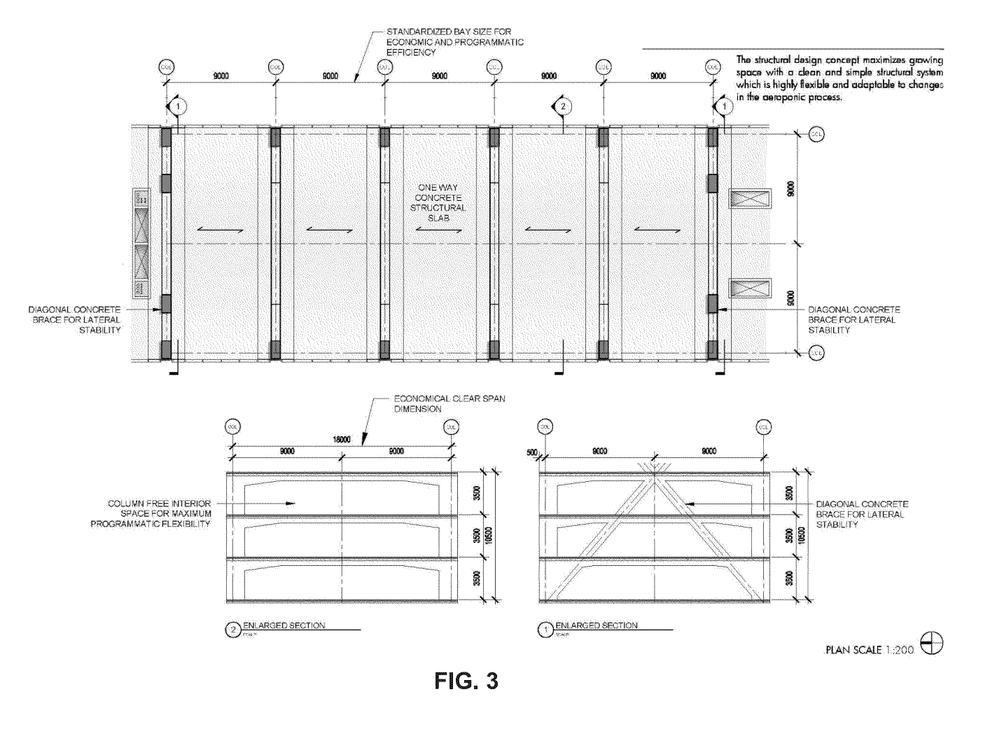

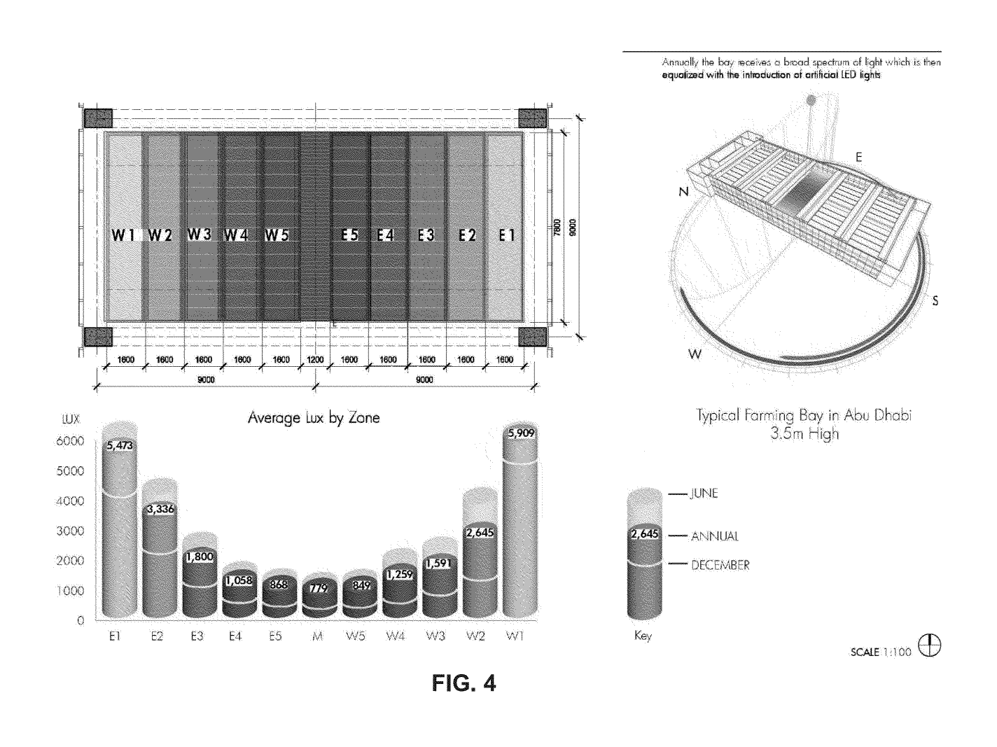

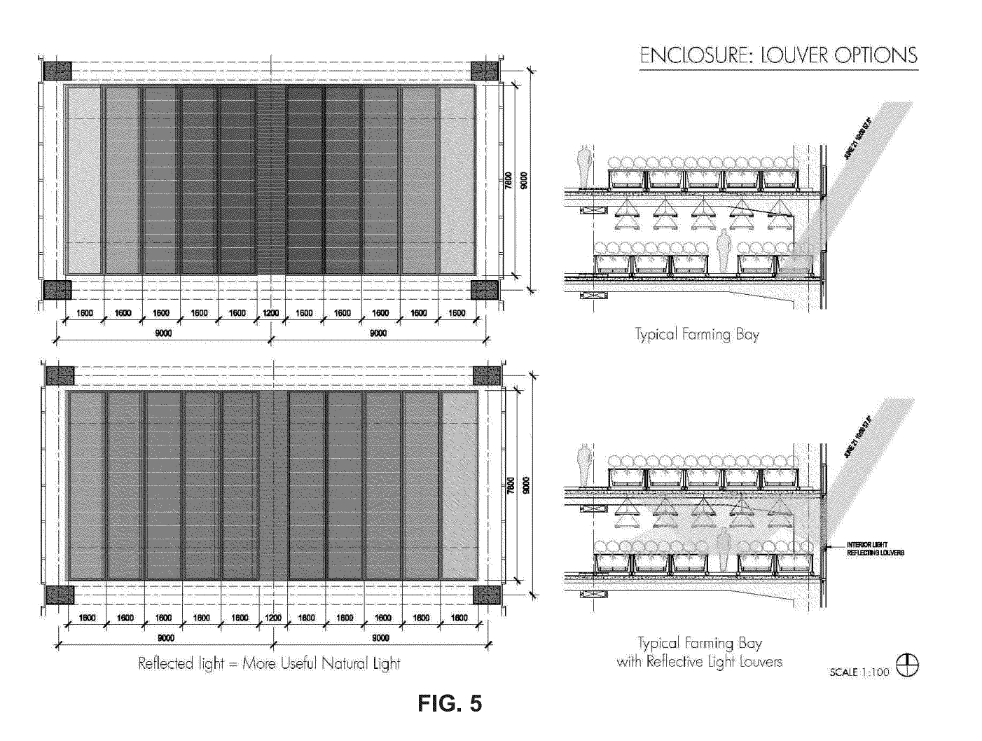

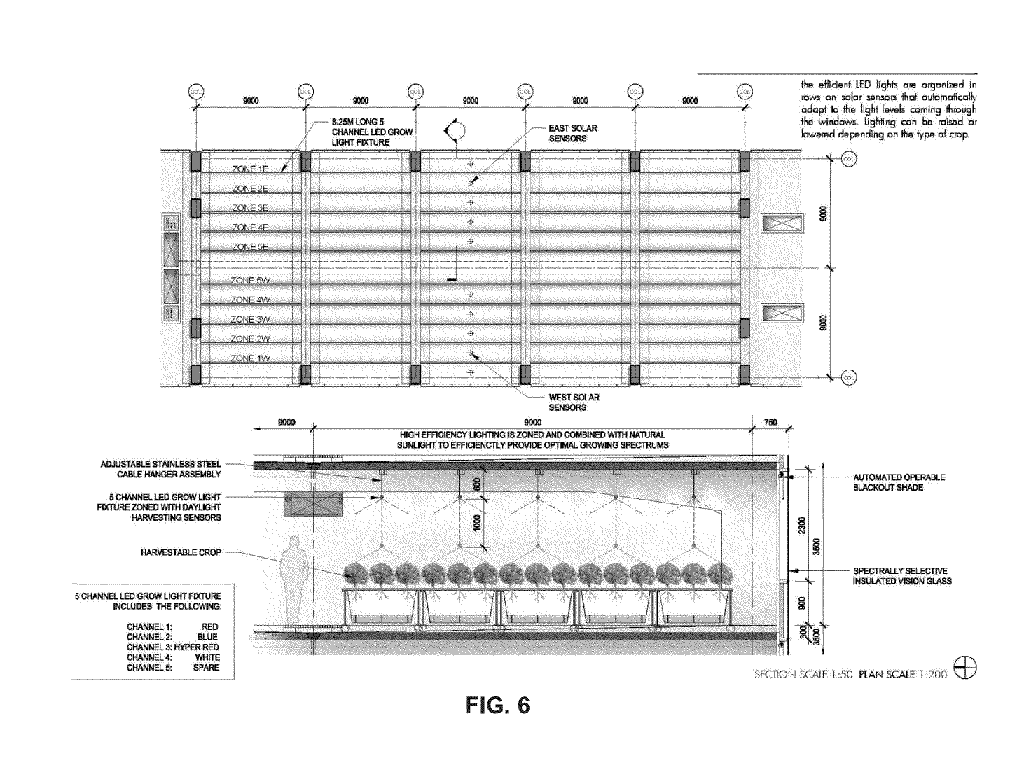

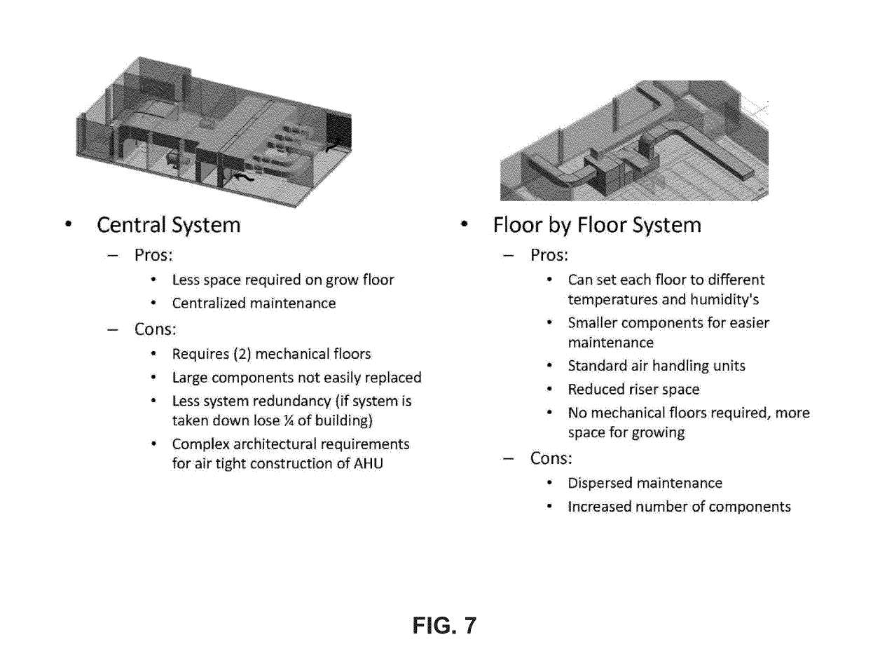

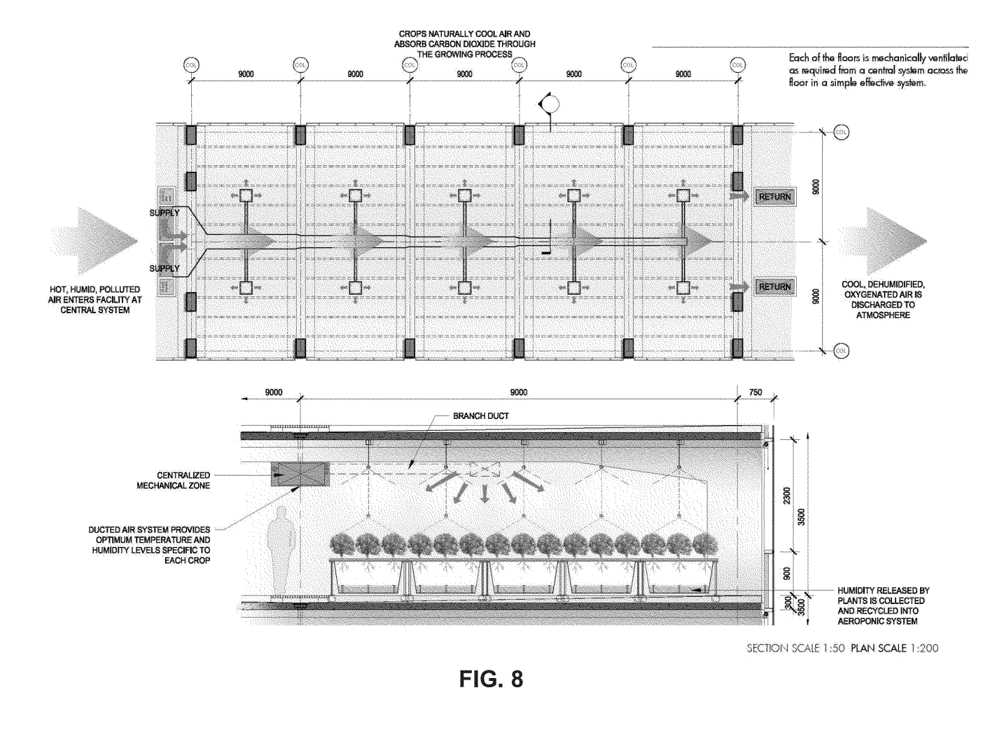

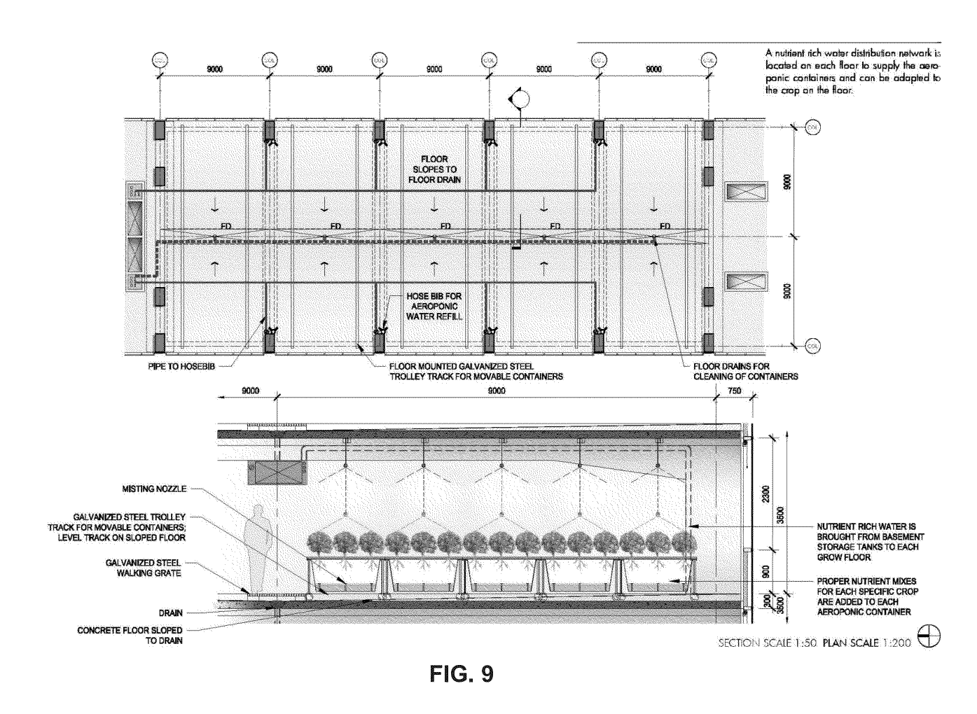

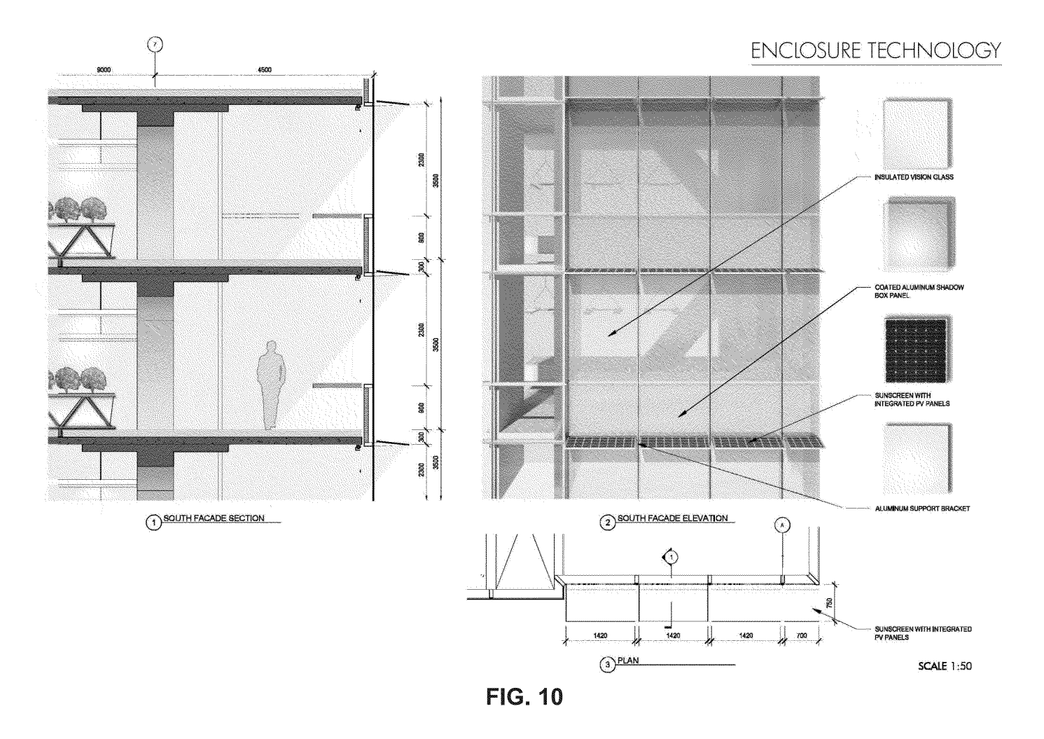

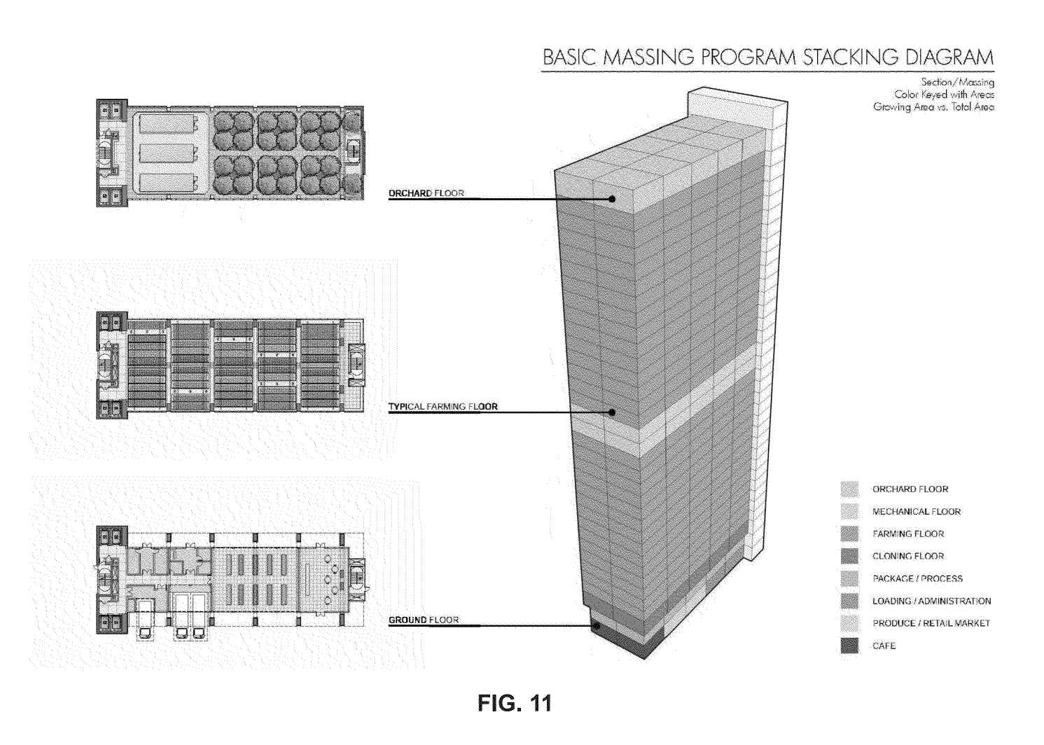

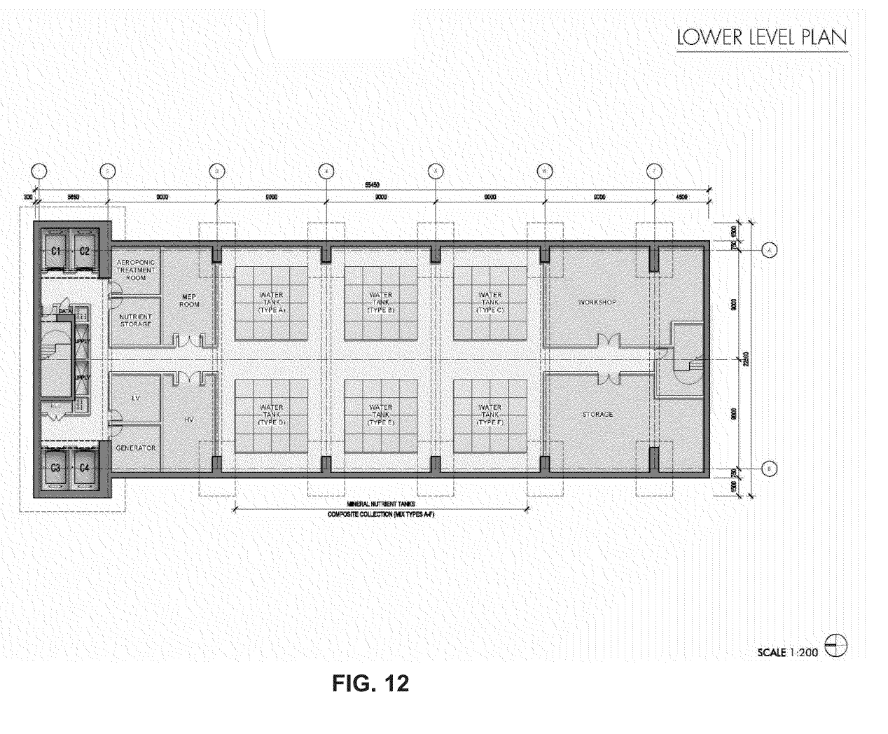

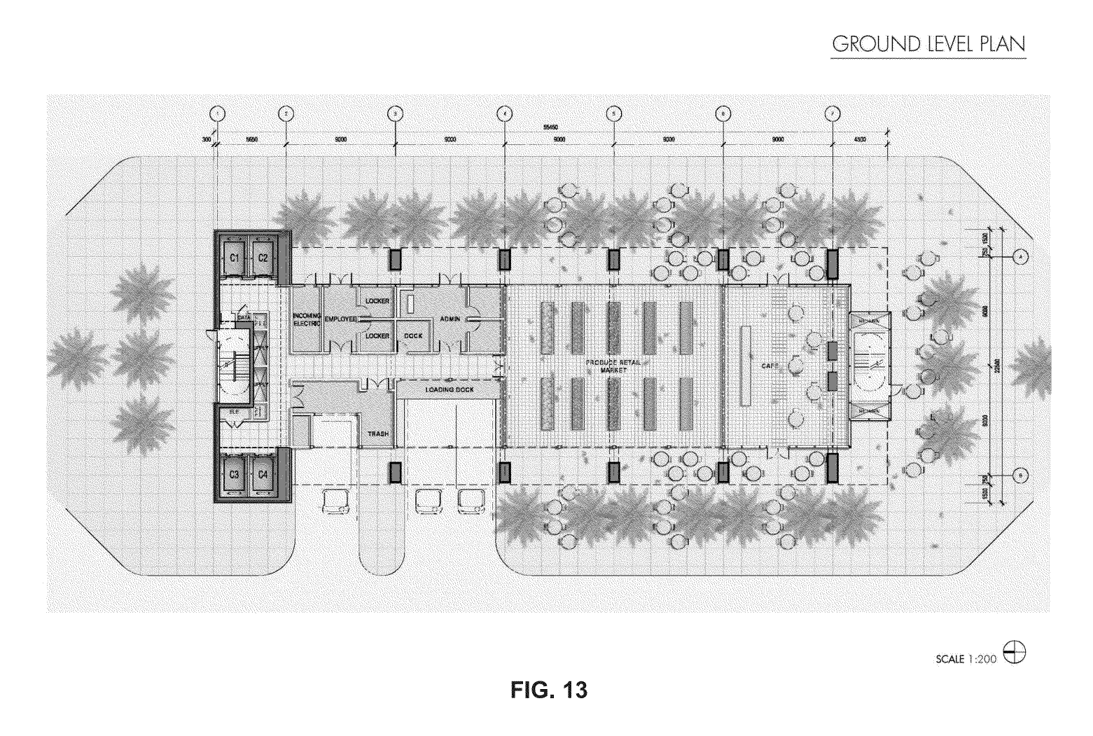

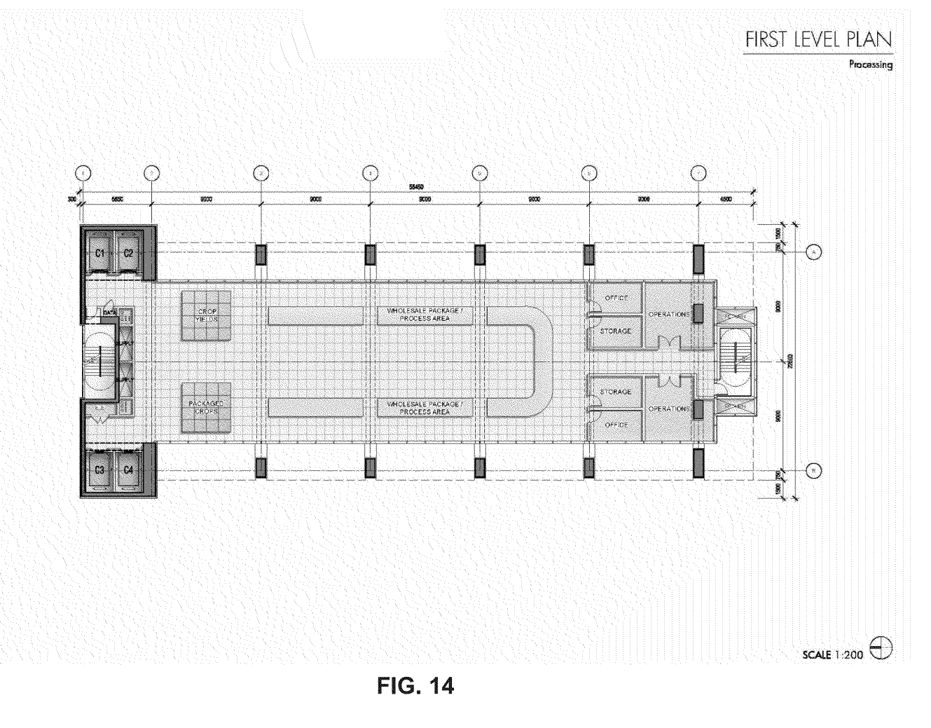

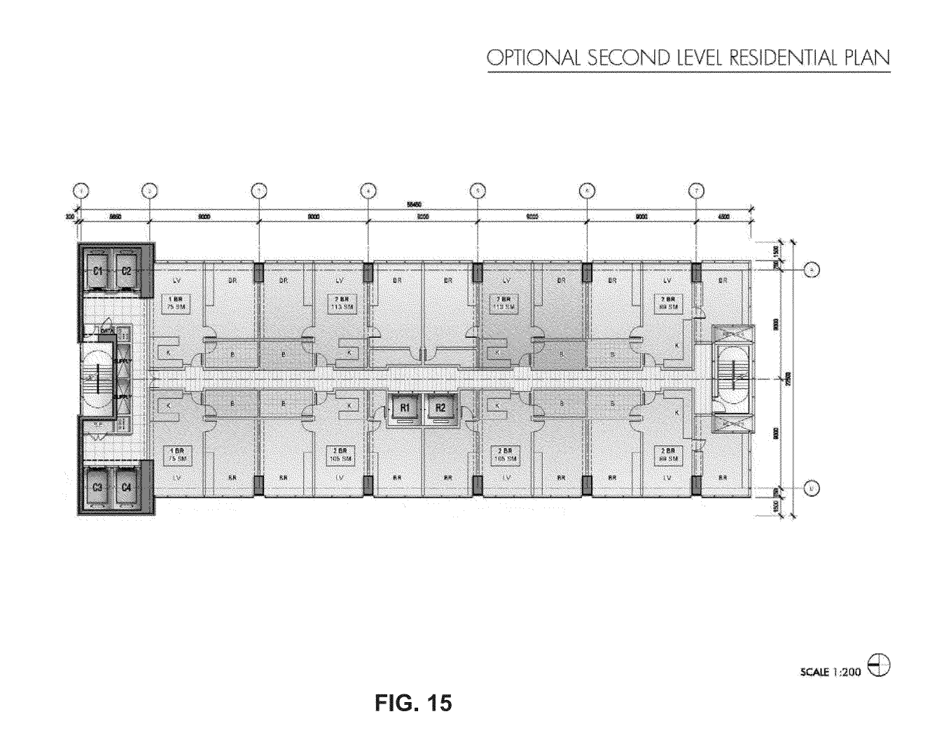

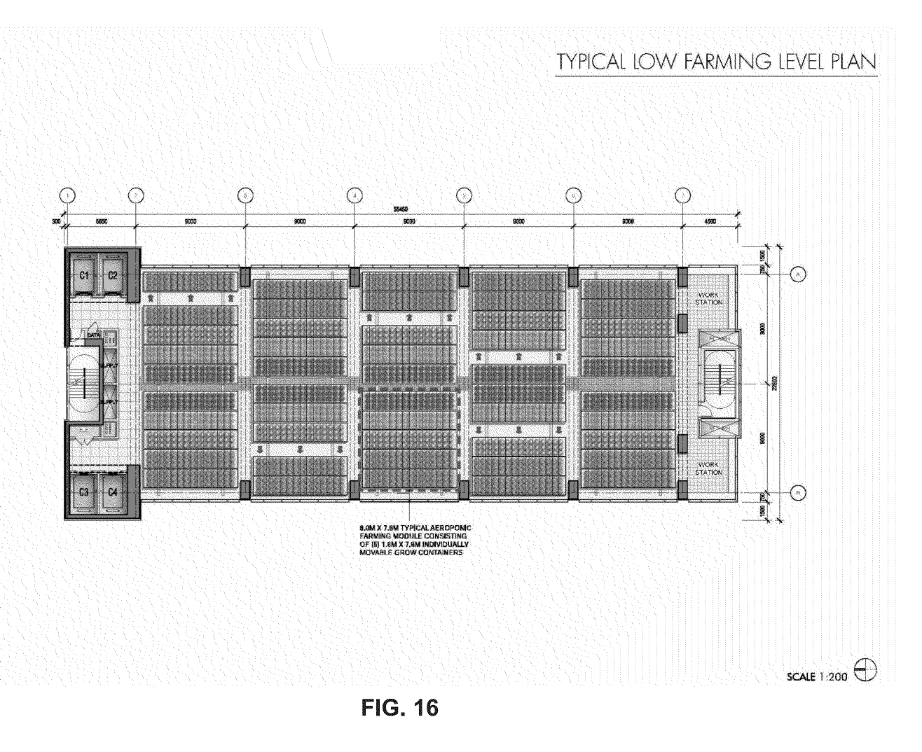

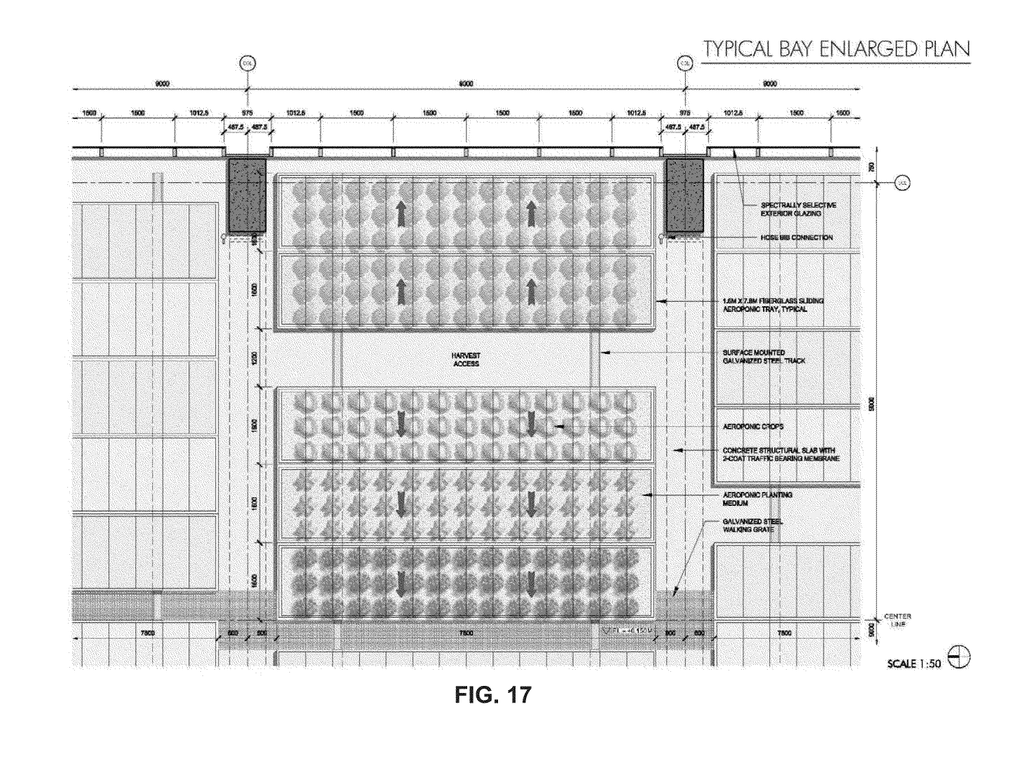

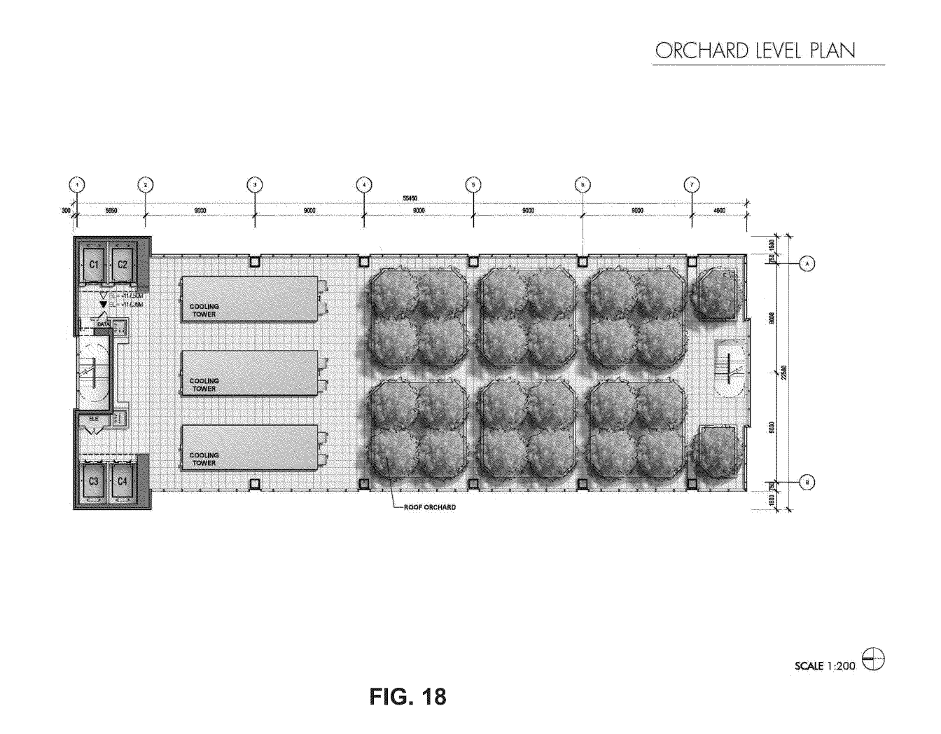

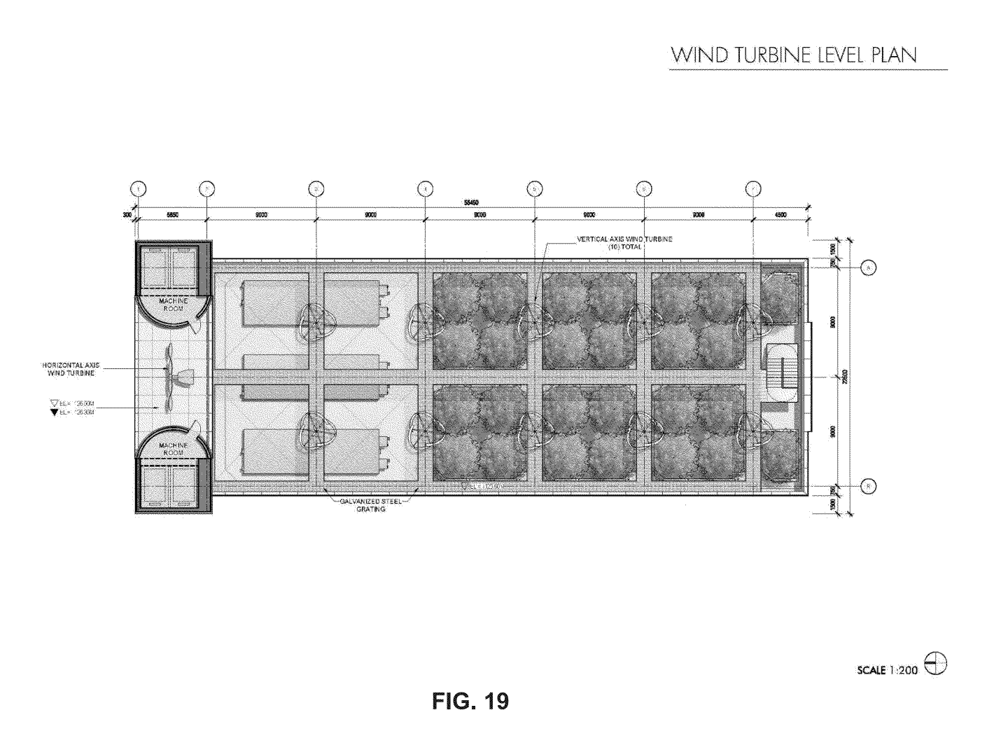

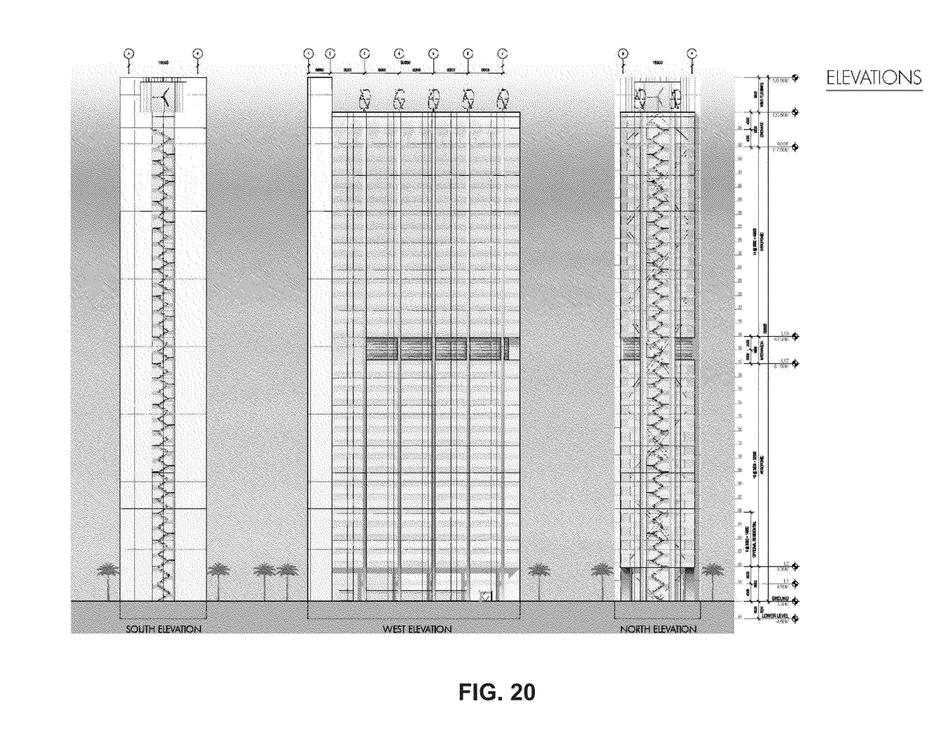

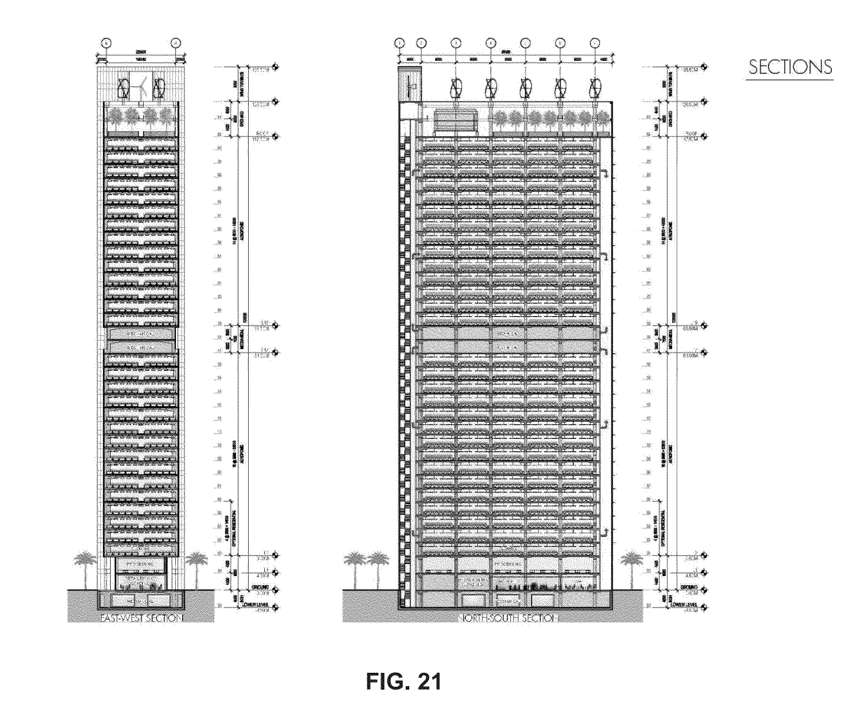

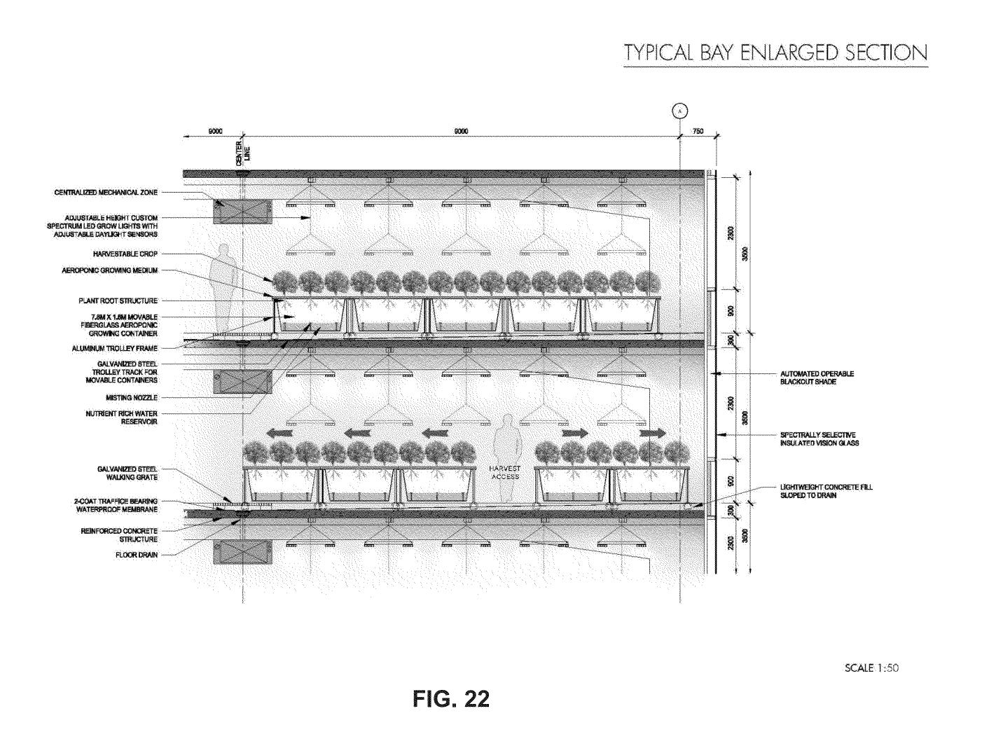

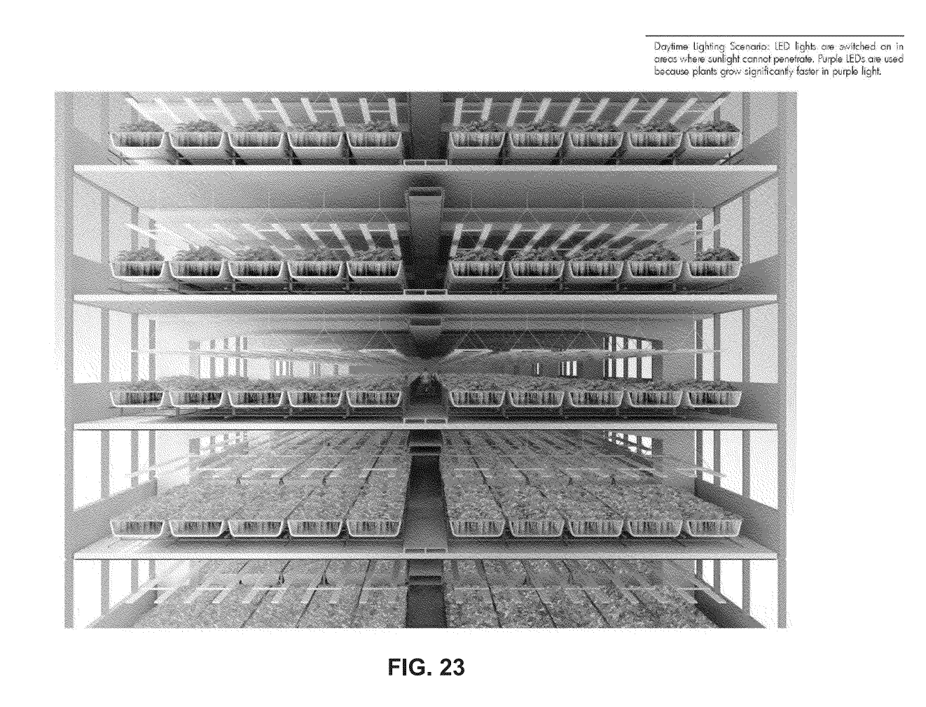

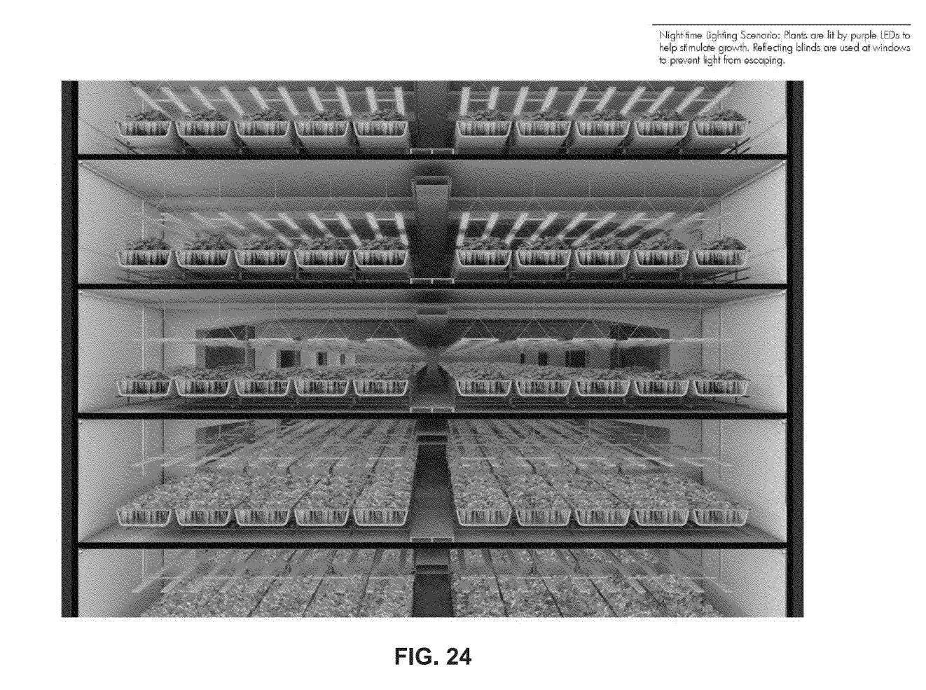

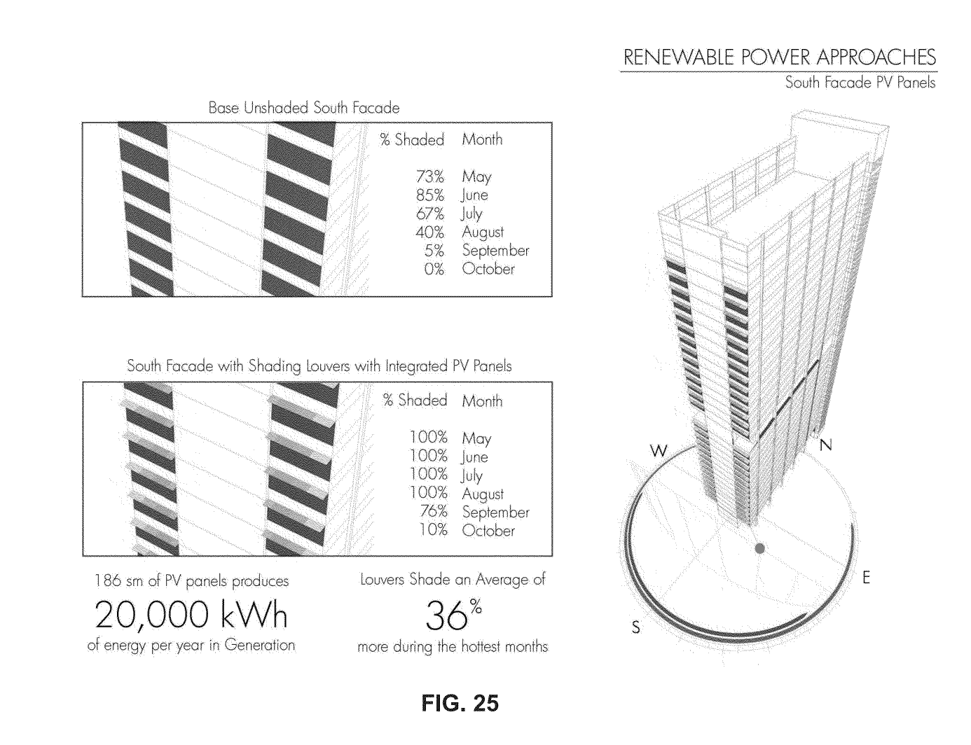

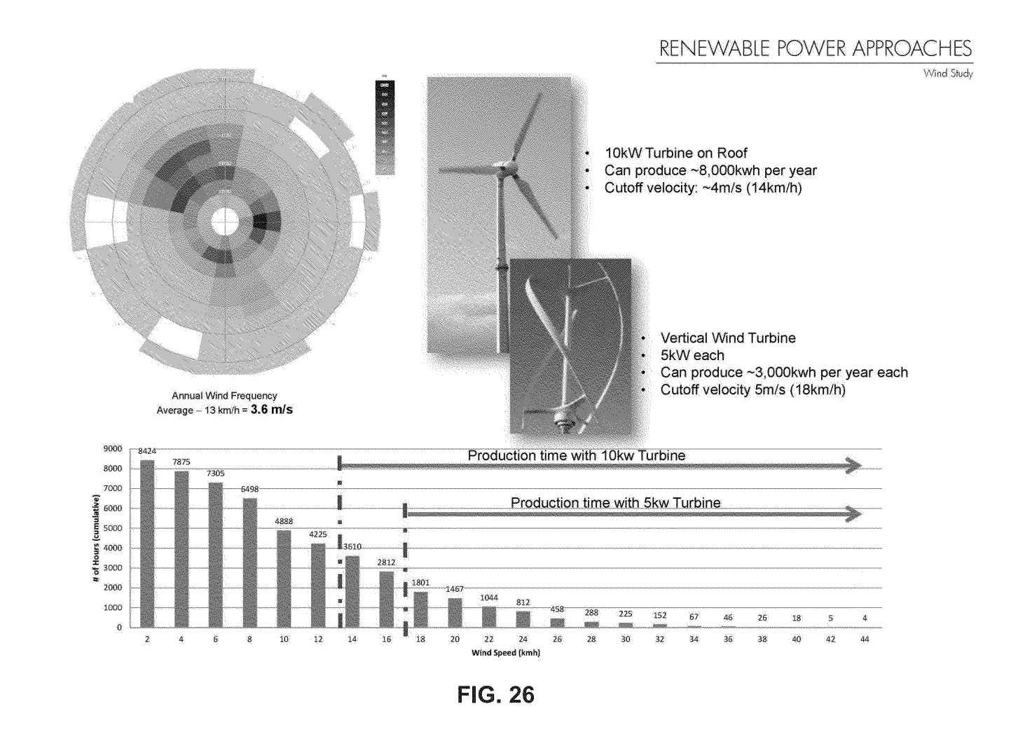

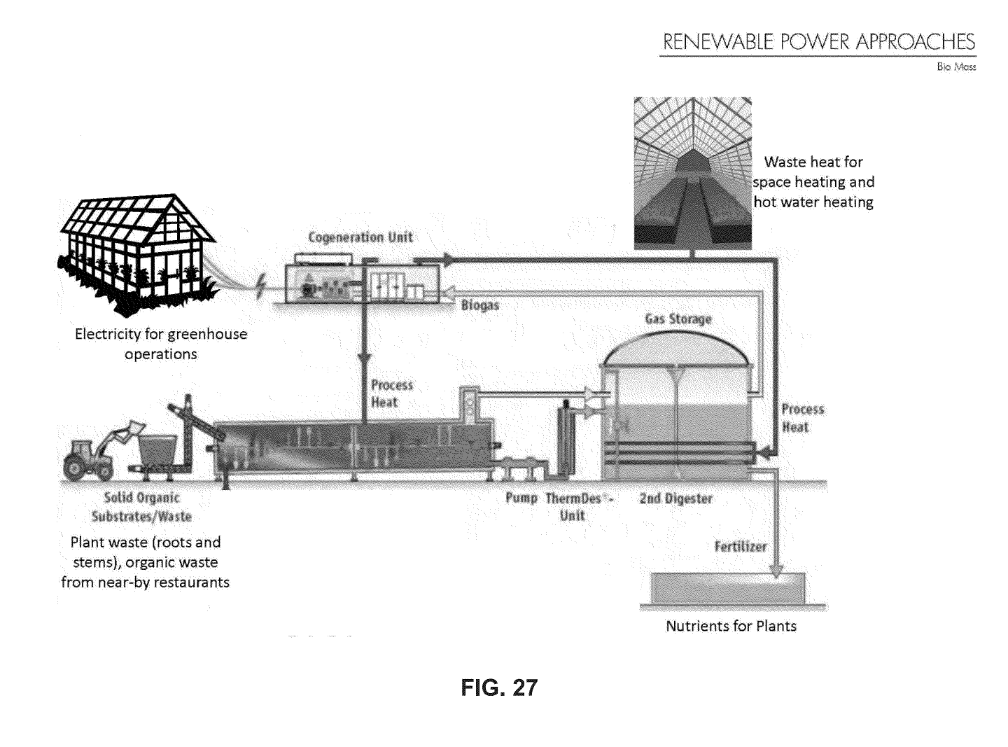

The FIGS. 1-27 depict various non-limiting aspects and embodiments of the VUAP.

A VUAP as disclosed herein may incorporate any number or combination of the aspects and embodiments described herein and which are generally illustrated and described in the accompanying Figures.

We claim:

1. A cultivation system, comprising
a plurality of stackable growth regions
wherein each growth region has substantially the same physical dimensions and comprises a plurality of growth bays,
wherein each of the plurality of growth bays comprises, in a vertically oriented dimension, from low to high:
a) a plant zone comprising one or a plurality of grow modules;
b) an airspace region located immediately above the plant zone;
c) a lighting region comprising a series of light emitting diode (LED) lights located above the airspace; and
d) a structural region, wherein the structural region provides structural support for (i) the LED lights of the lighting region, and (ii) an optional second growth region located above the structural region.

2. The cultivation system of claim 1, wherein the growth region further comprises exterior windows comprising a wavelength-specific high performance coating which provides high transmission of blue, red, and selected UV light spectrums and which reflects infrared heat.

3. The cultivation system of claim 1, further comprising solar control blinds that are optionally motorized and solar programmable, and which can reflect and redistribute natural ambient daylight to the interior regions of the floor.

4. The cultivation system of claim 1, further comprising further comprising a high performance light diffusion coating on at least a portion of a ceiling surface and/or a portion of a bottom surface of the individual floor, wherein the coating comprises mica or silicone beads, or both;

5. The cultivation system of claim 1, further comprising a HVAC system that is programmable and controls one or more of air exchange rates, temperature, and humidity on the individual floor, wherein the air exchange rate, temperature, and/or humidity that can be adjusted for any selected crop.

6. The cultivation system of claim 1, further comprising a condensate collection system which harvests water from HVAC coils during cooling and dehumidification cycles, wherein the water can optionally be collected for use in a grow module.

7. The cultivation system of claim 1, further comprising a floor plate geometry orientation and layout design that maximizes net grow module area, harvesting access and deep daylight penetration at east and west exposures.

8. The cultivation system of claim 1, comprising a purpose built structure comprising a plurality of individual floors that are each adapted for crop cultivation, wherein each individual floor has climate and growth conditions that are controllable independently from the climate and growth conditions of any of the other individual floors.

9. A purpose built structure comprising a plurality of individual floors that are each adapted for crop cultivation, wherein each individual floor has climate and growth conditions that are controllable independently from the climate and growth conditions of any of the other individual floors.

10. The structure of claim 9, further comprising a one or more movable grow modules designed for crop harvesting and modular in dimension;

11. The structure of claim 9, further comprising an artificial lighting comprising a programmable wavelength-specific light emitting diode (LED) system that comprises red, blue and white LEDs which provide wavelength specific lighting programmable for crop-specific selection and optionally solar controlled based on location of the LEDs within the floor.

12. The structure of claim 9, further comprising exterior windows comprising a wavelength-specific high performance coating which provides high transmission of blue, red, and selected UV light spectrums and which reflects infrared heat.

13. The structure of claim 9, further comprising solar control blinds that are optionally motorized and solar programmable, and which can reflect and redistribute natural ambient daylight to the interior regions of the floor;

14. The structure of claim 9, further comprising a high performance light diffusion coating on at least a portion of a ceiling surface and/or a portion of a bottom surface of the individual floor, wherein the coating comprises mica or silicone beads, or both.

15. The structure of claim 9, further comprising a HVAC system that is programmable and controls one or more of air exchange rates, temperature, and humidity on the individual floor, wherein the air exchange rate, temperature, and/or humidity that can be adjusted for any selected crop;

16. The structure of claim 9, further comprising a condensate collection system which harvests water from HVAC coils during cooling and dehumidification cycles, wherein the water can optionally be collected for use in a grow module; or

17. The structure of claim 9, having a floor plate geometry orientation and layout design that maximizes net grow module area, harvesting access and deep daylight penetration at east and west exposures.

18. The structure of claim 9, further comprising an organic waste digester and co-generation plant, wherein the organic waste digester can nutrient slurry for grow module units and methane gas for the co-generation plant, wherein the co-generation plant can provide power for the purpose built structure.

19. The structure of claim 9, further comprising an additional floor designed for process and packaging of crops harvested from the individual cultivation floors.

20. The structure of claim 9, further comprising a rooftop orchard comprising a screenwall and optional suspended catwalk areas provided for harvesting and building maintenance

21. The structure of claim 9, further comprising an additional floor designed for propagation for crop cuttings and crop cloning.

22. The structure of claim 9, further comprising renewable power sources selected from vertical wind turbines, horizontal wind turbines, and PV sunshade panels, or any combination thereof.
